(19) United States
(12) Patent Application Publication
(10) Pub. No.: US 2026/0066500 A1
(43) Pub. Date: Mar. 5, 2026

(54) SECONDARY BATTERY AND METHOD OF MANUFACTURING THE SAME

(71) Applicant: SAMSUNG SDI CO., LTD., Yongin-si (KR)

(72) Inventors: Taewoong JANG, Yongin-si (KR); Dae-Sup KIM, Yongin-si (KR)

(21) Appl. No.: 19/024,690

(22) Filed: Jan. 16, 2025

(30) Foreign Application Priority Data
Aug. 28, 2024 (KR) 10-2024-0116290

(51) Int. Cl. H01M 50/548; H01M 50/107; H01M 50/122; H01M 50/162; H01M 50/564

(52) U.S. Cl. CPC H01M 50/548; H01M 50/107; H01M 50/122; H01M 50/162; H01M 50/564

(57) ABSTRACT

A secondary battery includes an electrode assembly including a first electrode, a second electrode, a separator between the first and second electrodes, a first electrode tab connected to the first electrode, and a second electrode tab connected to the second electrode, a case that accommodates the electrode assembly and includes a top opening exposing an upper surface of the electrode assembly and a bottom opening exposing a lower surface of the electrode assembly, a cap plate combined with the case to cover a portion of the top opening, the cap plate having a conducting hole through which a remaining portion of the top opening of the case is exposed, an upper terminal plate above the cap plate and electrically connected to the first electrode tab through the conducting hole, and a lower terminal plate below the case and electrically connected to the second electrode tab through the bottom opening.

### CROSS-REFERENCE TO RELATED APPLICATION

The present application claims priority to and the benefit of Korean Application No. 10-2024-0116290, filed on Aug. 28, 2024, in the Korean Intellectual Property Office, the entire disclosure of which is incorporated by reference herein.

### BACKGROUND

### 1. Field

The present disclosure relates to a secondary battery and a method for manufacturing the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

According to aspects of embodiments, there is provided a secondary battery including an electrode assembly including a first electrode, a second electrode, a separator disposed between the first electrode and the second electrode, a first electrode tab connected to the first electrode, and a second electrode tab connected to the second electrode; a case that accommodates the electrode assembly, and includes a top opening through which an upper surface of the electrode assembly is exposed and a bottom opening through which a portion of a lower surface of the electrode assembly is exposed; a cap plate that is combined with the case to cover a portion of the top opening, and has a conducting hole formed therein through which a remaining portion of the top opening of the case is exposed; an upper terminal plate that is disposed above the cap plate and is electrically connected to the first electrode tab through the conducting hole; and a lower terminal plate that is disposed below the case and is electrically connected to the second electrode tab through the bottom opening.

According to an embodiment, the second electrode tab may include a first body and a second body, the first body may be disposed between the electrode assembly and a lower surface of the case, the first body may be electrically connected to the lower terminal plate, and the second body may be bent from the first body and electrically connected to the second electrode.

According to an embodiment, the case and the cap plate may each be formed of an insulating material.

According to an embodiment, the insulating material may be fiber-reinforced plastic (FRP).

According to an embodiment, a diameter of the upper terminal plate may be larger than a diameter of the top opening of the case.

According to an embodiment, a thickness of the cap plate may be thinner than a thickness of the case.

According to an embodiment, the diameter of the upper terminal plate and the diameter of the case may be the same.

According to an embodiment, a diameter of the lower terminal plate may be larger than the diameter of the top opening of the case.

According to an embodiment, the diameter of the lower terminal plate and the diameter of the case may be the same.

According to an embodiment, the diameter of the cap plate and the diameter of the case may be the same.

According to an embodiment, the cap plate and the case may be combined by plastic bonding.

According to an embodiment, the secondary battery may further include a first external terminal connected to the upper terminal plate, and a second external terminal connected to the lower terminal plate.

According to an embodiment, the first external terminal may include a first body and a second body, the first body may be in contact with the upper terminal plate, and the second body may be bent from the first body to be in contact with a side surface of the case.

According to an embodiment, the first external terminal may further include a third body, and the third body may be bent from the second body and extend away from the side surface of the case.

According to an embodiment, the second external terminal may include a first body and a second body, the first body may be in contact with the lower terminal plate, and the second body may be bent from the first body to be in contact with a side surface of the case.

According to an embodiment, the second external terminal may further include a third body, and the third body may be bent from the second body and extend away from the side surface of the case.

According to an embodiment, the upper terminal plate may include a first flat portion disposed above the cap plate and a first protrusion protruding on the first flat portion, the first protrusion may be received in the conducting hole of the cap plate, and the first protrusion may be electrically connected to the first electrode tab.

According to an embodiment, the lower terminal plate may include a second flat portion disposed on the lower surface of the case and a second protrusion protruding on the second flat portion, the second protrusion may be received in the bottom opening of the case, and the second protrusion may be electrically connected to the second electrode tab.

According to aspects of embodiments, there is provided a method for manufacturing a secondary battery, including a first step of preparing an electrode assembly including a first electrode, a second electrode, a separator disposed between the first electrode and the second electrode, a first electrode tab connected to the first electrode, and a second electrode tab connected to the second electrode; a second step of inserting the electrode assembly into a case including a top opening through which an upper surface of the electrode assembly is exposed and a bottom opening through which a portion of a lower surface of the electrode assembly is exposed; a third step of combining the case and the cap assembly; and a fourth step of placing a lower terminal plate that is electrically connected to the second electrode tab through the bottom opening, below the case, in which the cap assembly includes a cap plate that is combined with the case to cover a portion of the top opening, and has a conducting hole formed therein through which a remaining portion of the top opening of the case is exposed, and an upper terminal plate that is disposed above the cap plate and is electrically connected to the first electrode tab through the conducting hole.

According to an embodiment, the case and the cap plate may be each formed of an insulating material, and the third step may include a step of bonding the cap plate and the case by plastic bonding.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-sectional view of a secondary battery according to an exemplary embodiment.

FIG. 2A is a perspective view of the secondary battery in FIG. 1 according to an exemplary embodiment.

FIG. 2B is an exploded view of the secondary battery in FIG. 2A according to the exemplary embodiment.

FIG. 3 is a cross-sectional view of a secondary battery according to an exemplary embodiment.

FIG. 4A is a cross-sectional view of a secondary battery according to an exemplary embodiment.

FIG. 4B is a cross-sectional view of a secondary battery according to an exemplary embodiment.

FIG. 5 is a cross-sectional view of a secondary battery according to an exemplary embodiment.

FIG. 6 is a detailed view showing a cross-section of a secondary battery according to an exemplary embodiment and a part thereof.

FIG. 7 is a cross-sectional view of a secondary battery according to an exemplary embodiment.

FIG. 8 is a diagram showing a cross-section of a secondary battery according to an exemplary embodiment and a fastening process by a fastening portion.

FIG. 9 is a cross-sectional view of a secondary battery according to an exemplary embodiment.

FIG. 10 is a flow chart of a method for manufacturing a secondary battery, according to an exemplary embodiment.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The major axis used in this specification refers to a line segment connecting two points that are the longest distance apart from each other, among points included in the perimeter of a plane figure.

In this specification, the expression “A covers B” may mean, when viewed in a plan view, “A is disposed so that B is covered by A.”

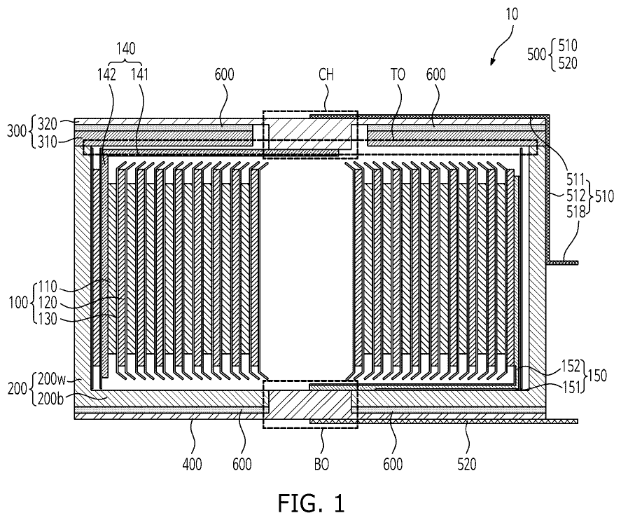

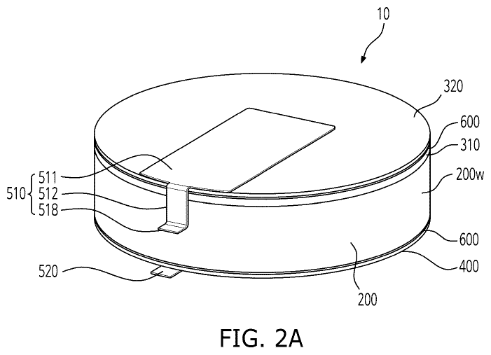

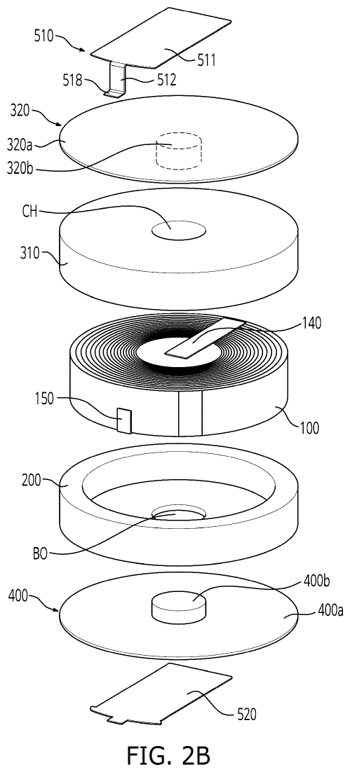

FIG. 1 is a cross-sectional view of a secondary battery according to an exemplary embodiment. FIG. 2A is a perspective view of the secondary battery according to the exemplary embodiment of FIG. 1, and FIG. 2B is a view schematically showing an exploded view of the secondary battery according to the exemplary embodiment of FIG. 1.

According to FIGS. 1 to 2B, a secondary battery 10 according to an exemplary embodiment may include an electrode assembly 100 including a first electrode 110, a second electrode 120, a separator 130 disposed between the first electrode 110 and the second electrode 120, a first electrode tab 140 connected to the first electrode 110, and a second electrode tab 150 connected to the second electrode 120, a case 200 that accommodates the electrode assembly 100 and includes a top opening TO through which an upper surface of the electrode assembly 100 is exposed and a bottom opening BO through which a portion of a lower surface of the electrode assembly is exposed, a cap plate 310 that is combined with the case 200 to cover a portion of the top opening TO and has a conducting hole CH formed therein through which a remaining portion of the top opening of the case 200 is exposed, an upper terminal plate 320 that is disposed above the cap plate 310 and is electrically connected to the first electrode tab 140 through the conducting hole CH, and a lower terminal plate 400 that is disposed below the case 200 and is electrically connected to the second electrode tab 150 through the bottom opening. The cap plate 310 and the upper terminal plate 320 may be included in the cap assembly 300.

The secondary battery 10 according to the exemplary embodiment may further include a first external terminal 510 connected to the upper terminal plate 320 and a second external terminal 520 connected to the lower terminal plate 400. The upper terminal plate 320 may include a first flat portion 320a disposed above the cap plate 310 and a first protrusion 320b protruding from the first flat portion 320a and received in the conducting hole CH. The lower terminal plate 400 may include a second flat portion 400a disposed on the lower surface of the case 200, and a second protrusion 400b protruding from the second flat portion 400a and received in the bottom opening BO.

The first external terminal 510 may include a first body 511 and a second body 512. In this case, the first body 511 may be a portion disposed above the upper terminal plate 320 (e.g., in parallel to the first flat portion 320a of the upper terminal plate 320), and the second body 512 may be a portion bent from the first body 511 and disposed in contact with a side wall 200w of the case 200 (e.g., along the side wall 200w and perpendicularly with respect to the first body 511). Additionally, the first external terminal 510 may further include an additional body 518. In this case, the additional body 518 may be bent from the second body 512 and extended in a direction oriented away from the side wall 200w of the case 200 (e.g., the first and additional bodies 511 and 518 may be parallel to each other and extend in opposite directions).

The electrode assembly 100 of the secondary battery 10 according to an exemplary embodiment may include the first electrode 110, the second electrode 120, the separator 130, the first electrode tab 140, and the second electrode tab 150. The separator 130 may be disposed between the first electrode 110 and the second electrode 120 such that the first electrode 110 and the second electrode 120 are separated from each other and electrically insulated from each other. The separator 130 may contain an insulating material. The first electrode tab 140 may be disposed to be connected to the first electrode 110, and the second electrode tab 150 may be disposed to be connected to the second electrode 120. For example, the electrode assembly 100 may be configured by winding the first electrode 110, the second electrode 120, and the separator 130. In this case, the electrode assembly 100 may be wound to form a core, and may include a through hole in the core. In another example, the first electrode 110, the second electrode 120, and the separator 130 may be stacked in layers.

In an embodiment, the first electrode 110 may include a substrate and an active material layer disposed on the substrate. A portion of the substrate where the active material layer is not disposed may correspond to a non-coated portion, and a portion of the substrate where the active material layer is disposed may correspond to a mixture portion. A tab may be formed in the non-coated portion. The tab portion of the first electrode 110 may be in contact with the first electrode tab 140, and thus the tab portion of the first electrode 110 may be electrically connected to the first electrode tab 140.

In an embodiment, the second electrode 120 may include a substrate and an active material layer disposed on the substrate. A portion of the substrate where the active material layer is not disposed may correspond to a non-coated portion, and a portion of the substrate where the active material layer is disposed may correspond to a mixture portion. A tab may be formed in the non-coated portion. The tab portion of the second electrode 120 may be in contact with the second electrode tab 150, and thus the tab portion of the second electrode 120 may be electrically connected to the second electrode tab 150.

In an embodiment, the first electrode tab 140 may be in contact with the upper terminal plate 320 of the cap assembly 300 and thus be electrically connected to the upper terminal plate 320. The second electrode tab 150 may be in contact with the lower terminal plate 400 and thus be electrically connected to the lower terminal plate 400.

The first electrode 110 may be either an anode or a cathode, and the second electrode 120 may be the other of the anode or cathode. The first electrode 110 and the second electrode 120 may have opposite polarities. For example, when the first electrode 110 is an anode, the second electrode 120 may be a cathode. In this case, the active material layer included in the first electrode 110 may be a positive electrode active material layer, and the active material layer included in the second electrode 120 may be a negative electrode active material layer. For example, the positive electrode active material layer may include a transition metal oxide, and the negative electrode active material layer may include graphite. In addition, in the case described above, examples of the substrate included in the first electrode 110 may include an aluminum (Al) foil, and examples of the substrate included in the second electrode 120 may include a copper (Cu) or nickel (Ni) foil. However, various materials suitable for the polarity of the substrate or active material layer may be included.

The separator 130 may electrically insulate the first electrode 110 and the second electrode 120 while allowing the movement of specific ions. That is, it may have a function of preventing short circuit between the first electrode 110 and the second electrode 120. For example, the separator 130 may include, a polyethylene film, a polypropylene film, a polyethylene-polypropylene film, etc.

In an embodiment, the first electrode tab 140 may be connected to at least one tab portion formed on the first electrode 110 and may electrically connect the first electrode 110 and the upper terminal plate 320. The second electrode tab 150 may be connected to at least one tab portion formed on the second electrode 120 and may electrically connect the second electrode 120 and the lower terminal plate 400.

The first electrode tab 140 may include a first body 141 and a second body 142. The first body 141 of the first electrode tab 140 may be disposed between the electrode assembly 100 and the cap plate 310. The first body 141 of the first electrode tab 140 may be electrically connected to the upper terminal plate 320. The second body 142 of the first electrode tab 140 may be bent from the first body 141 of the first electrode tab 140 and electrically connected to the first electrode 110.

The second electrode tab 150 may include a first body 151 and a second body 152. The first body 151 of the second electrode tab 150 may be disposed between the electrode assembly 100 and the bottom 200b of the case 200. The first body 151 of the second electrode tab 150 may be electrically connected to the lower terminal plate 400. The second body 152 of the second electrode tab 150 may be bent from the first body 151 of the second electrode tab 150 and electrically connected to the second electrode 120.

The secondary battery 10 according to an exemplary embodiment may include a case 200. The case 200 may include the top opening TO through which the upper surface of the electrode assembly 100 may be exposed and the bottom opening BO through which a portion of the lower surface of the electrode assembly 100 may be exposed. The bottom opening BO may be disposed at the lower part of the case 200, and thus a portion of the lower surface of the electrode assembly 100 accommodated in the case 200 may be exposed through the bottom opening BO.

The case 200 may have a well structure with the bottom opening BO and may accommodate the electrode assembly 100. The case 200 may surround a portion of the lower surface and side surfaces of the electrode assembly 100.

For example, the case 200 may have a three-dimensional shape in which one base area is missing from a cylinder and the other base area includes an opening. The part without a base area may correspond to the top opening TO. The base area having the opening may be a surface including the bottom opening BO. In this case, the cylinder may have a certain thickness. In another example, the cylinder may be thinner at the base than at the top. However, the case 200 may have various shapes suitable for use in a square shape, a pouch shape, etc.

The case 200 may include the bottom 200b and the side wall 200w. The bottom 200b of the case 200 may cover a portion of the lower surface of the electrode assembly 100. In this case, another portion of the lower surface of the electrode assembly 100 that is not covered by the bottom 200b of the case 200 may be exposed through the bottom opening BO. The bottom 200b of the case 200 may be disposed on the lower terminal plate 400. For example, the bottom 200b of the case 200 may be disposed in contact with the lower terminal plate 400. In another example, the bottom 200b of the case 200 may be disposed in contact with an adhesive layer 600 that bonds the bottom 200b of the case 200 to the lower terminal plate 400.

The side wall 200w of the case 200 may surround the side surface of the electrode assembly 100. The side wall 200w of the case 200 may include an inner surface and an outer surface. The inner surface of the side wall 200w of the case 200 may surround the electrode assembly 100 while facing it, and the second body 512 of the first external terminal 510 may be disposed in contact with the outer surface of the side wall 200w of the case 200.

At the section where the bottom 200b and the side wall 200w of the case 200 intersect each other on the cross-section of the case 200, the bottom 200b and the side wall 200w of the case 200 may partially overlap. In cross-section, a region equal to the thickness of the side wall 200w at the left and right edges of the bottom 200b of the case 200 may be a region where the bottom 200b of the case 200 partially overlaps the side wall 200w of the case 200. In cross-section, a region equal to the thickness of the bottom 200b from the lower edge of the side wall 200w of the case 200 may be a region where the side wall 200w of the case 200 partially overlaps the bottom 200b of the case 200.

The length of the major axis (or diameter) of the planar shape of the bottom opening BO of the case 200 may be smaller than the length of the major axis (or diameter) of the planar shape of the bottom 200b of the case 200. Additionally, the planar shape of the bottom opening BO may have various shapes as needed. For example, the planar shape of the bottom opening BO may be selected to facilitate the accommodation of the electrode assembly 100 and the placement of the lower terminal plate 400. For example, the planar shape of the bottom opening BO may be a similar figure with different size and shape from the outer perimeter of the planar shape of the bottom 200b of the case 200. For example, in a case where the plane of the bottom 200b of the case 200 has a ring shape (or a disk shape or annulus having an opening), the planar shape of the bottom opening BO may be a circular shape. However, the two shapes may be different from each other.

The case 200 may contain an insulating material and/or be formed of an insulating material. For example, the insulating material may include a plastic, an insulating silicone compound, or an insulating metal compound. The plastic may include reinforced plastics, and the reinforced plastic may include fiber-reinforced plastics (FRP). Fiber-reinforced plastics FRP may include glass-fiber reinforced plastics, carbon-fiber reinforced plastics, etc. According to an exemplary embodiment, the case 200 may include fiber-reinforced plastic (FRP). Because the case 200 contains an insulating material, even when the first external terminal 510 comes into contact with the case 200, a short circuit may not occur between the first external terminal 510 and the second external terminal 520.

In a case where the case 200 contains an insulating material, even when damage occurs to the first external terminal 510, problems such as insulation breakdown and short circuit due to this may be less likely to occur, or may not occur.

The secondary battery 10 according to the exemplary embodiment may include a cap assembly 300. The cap assembly 300 may include a cap plate 310 and an upper terminal plate 320, and may cover the upper surface of the electrode assembly 100 received in the case 200. The cap plate 310 may be combined with the case 200 to cover a portion of the top opening TO and may include the conducting hole CH through which the remaining portion of the top opening TO of the case 200 is exposed. The upper terminal plate 320 may be disposed above the cap plate 310 and may be electrically connected to the first electrode tab 140 through the conducting hole CH.

The cap plate 310 may include the conducting hole CH and may be disposed on the top opening TO to cover a portion of the upper surface of the electrode assembly 100. The remaining portion of the upper surface of the electrode assembly 100 that is not covered by the cap plate 310 may be exposed through the conducting hole CH. The cap plate 310 may be combined with the side wall 200w of the case 200. For example, the cap plate 310 may be combined with the upper surface of the side wall 200w of the case 200, or may be combined with the inner surface of the side wall 200w of the case 200. The cap plate 310 and the side wall 200w of the case 200 may be attached in various ways. For example, the cap plate 310 and the case 200 may be combined by plastic bonding or bonded using resin.

The shape of the cap plate 310 may be selected according to the planar shape of the upper surface of the electrode assembly 100 and/or the planar shape of the top opening TO. The shape of the cap plate 310 may be selected to cover the upper surface of the electrode assembly 100 except for the portion where the conducting hole CH is formed. For example, the cap plate 310 may have a three-dimensional shape such as a ring shape (or a disk shape or annulus having an opening) having a thickness. In this case, the empty center of the ring may correspond to the conducting hole CH. However, the cap plate 310 may have various shapes suitable for use in a square shape, a pouch shape, etc.

The length of the major axis of the planar shape of the conducting hole CH of the cap plate 310 may be shorter than the length of the major axis of the planar shape of the cap plate 310. Additionally, the planar shape of the conducting hole CH may have various shapes as needed. For example, the planar shape of the conducting hole CH may be selected to facilitate the placement of the upper terminal plate 320. For example, the planar shape of the conducting hole CH may be a similar figure with different size and shape from the outer perimeter of the planar shape of the bottom 200b of the case 200. For example, when the plane of the bottom 200b of the case 200 has a ring shape, the planar shape of the conducting hole CH may be a circular shape. However, the two shapes may be different from each other.

The cap plate 310 may extend onto the side wall 200w of the case 200. That is, the cap plate 310 may be disposed on the side wall 200w of the case 200. For example, the cap plate 310 may be disposed to partially cover the upper portion of the side wall 200w of the case 200, or may be disposed to substantially cover the entire upper portion of the side wall 200w of the case 200. For example, in the case of a coin-type secondary battery, the diameter of the cap plate 310 and the diameter of the case 200 may be substantially the same.

In an embodiment, the thickness of the cap plate 310 may be thinner than the thickness of the case 200. Accordingly, a secondary battery with high energy density, in which more space inside the case 200 and cap plate 310 may be secured, may be provided.

The cap plate 310 may contain an insulating material. For example, the insulating material may include a plastic, an insulating silicone compound, or an insulating metal compound. The plastic may include reinforced plastics, and the reinforced plastic may include fiber-reinforced plastics (FRP). Fiber-reinforced plastics (FRP) may include glass-fiber reinforced plastics, carbon-fiber reinforced plastics, etc. According to an exemplary embodiment, the case 200 may include fiber-reinforced plastic (FRP). The cap plate 310 may contain the same type of insulating material as the insulating material included in the case 200, or may contain a different type of insulating material. In this case, each insulating material may be selected such that the cap plate 310 and the case 200 may be attached well. The cap plate 310 and the case 200 may be combined by plastic bonding. For example, the cap plate 310 may also include a conductor. In this case, because the case 200 is formed of an insulating material, even when the cap plate 310 includes a conductor, the first electrode 110 and the second electrode 120 may be electrically insulated.

The upper terminal plate 320 may be disposed on the cap plate 310 and fill the conducting hole CH. For example, the upper terminal plate 320 may be disposed in contact with the cap plate 310. In another example, the upper terminal plate 320 may be disposed in contact with an adhesive layer 600 that bonds the upper terminal plate 320 and the cap plate 310.

The upper terminal plate 320 may include a flat portion 320a and a protrusion 320b protruding from the flat portion 320a. The flat portion 320a may be disposed on the cap plate 310, and the protrusion 320b may be received in the conducting hole CH. For example, the protrusion 320b may partially or completely fill the conducting hole CH. The cap assembly 300 may cover the top opening TO because the protrusion 320b is disposed and received in the conducting hole CH and the flat portion 320a is disposed on the cap plate 310. That is, the cap assembly 300 may cover the upper surface of the electrode assembly 100. Even when the protrusion 320b fills a portion of the conducting hole CH, the upper part of the electrode assembly 100 may be hermetically sealed because the cap plate 310 and the upper terminal plate 320 are disposed in contact with each other or an adhesive layer 600 is disposed between the cap plate 310 and the upper terminal plate 320.

The upper terminal plate 320 may extend to the upper part of the side wall 200w of the case 200. That is, the upper terminal plate 320 may be disposed above the side wall 200w of the case 200. Accordingly, the area of the planar shape of the flat portion 320a of the upper terminal plate 320 may be expanded. For example, the upper terminal plate 320 may extend over the side wall 200w of the case 200 and cover a portion of the upper part of the side wall 200w of the case 200. In the case of a coin-type battery, the diameter of the upper terminal plate 320 may be larger than the diameter of the top opening TO of the case 200. In this case, the diameter of the upper terminal plate 320 may be the diameter of the planar shape of the flat portion 320a of the upper terminal plate 320.

According to another example, the upper terminal plate 320 may substantially cover the entire upper portion of the side wall 200w of the case 200. In this case, the area of the planar shape of the flat portion 320a of the upper terminal plate 320 may be substantially equal to the area defined by the outer perimeter of the plane of the bottom 200b of the case 200. For example, in the case of a coin-type battery, the area of a circle which is the planar shape of the flat portion 320a of the upper terminal plate 320 may be substantially equal to the area of a circle having an outer radius of a ring which is a planar shape of a bottom 200b of the case 200. That is, the diameter of the upper terminal plate 320 and the diameter of the bottom 200b of the case 200 may be substantially the same. In this case, the diameter of the upper terminal plate 320 may be the diameter of the planar shape of the flat portion 320a of the upper terminal plate 320, and the diameter of the bottom 200b of the case 200 may be the outer diameter of the ring when the bottom 200b has a ring shape.

When the upper terminal plate 320 included in the secondary battery 10 according to the exemplary embodiment extends over the side wall 200w of the case 200, a phenomenon of the secondary battery 10 being bent or cracked by an external force may be reduced. Accordingly, a secondary battery in which stress may be well distributed may be provided. This may increase the strength of the case 200 or the cap plate 310 when reducing the thickness of the case 200 or the cap plate 310 to increase energy density.

In the case where the secondary battery 10 according to the exemplary embodiment includes an adhesive layer 600 disposed between the cap plate 310 and the upper terminal plate 320, the adhesive layer 600 may also be disposed to extend over the side wall 200w of the case 200 together with the upper terminal plate 320.

The secondary battery 10 according to an exemplary embodiment may include the lower terminal plate 400. The lower terminal plate 400 may be disposed below the case 200 and may be electrically connected to the second electrode tab 150 through the bottom opening BO. The lower terminal plate 400 may fill the bottom opening BO. For example, the lower terminal plate 400 may be disposed in contact with the bottom 200b of the case 200. In another example, the lower terminal plate 400 may be disposed in contact with an adhesive layer 600 that bonds the lower terminal plate 400 and the bottom 200b of the case 200.

The lower terminal plate 400 may include a flat portion 400a and a protrusion 400b protruding from the flat portion 400a. The flat portion 400a may be disposed under the bottom 200b of the case 200, and the protrusion 400b may be received in the bottom opening BO. For example, the protrusion 400b may partially or completely fill the bottom opening BO. The protrusion 400b is received in the bottom opening BO, and the lower terminal plate 400 is disposed under the bottom 200b of the case 200, so that the case 200 and the lower terminal plate 400 may cover the lower surface of the electrode assembly 100. Even when the protrusion 400b fills a portion of the bottom opening BO, the lower portion of the electrode assembly 100 may be hermetically sealed because the bottom 200b of the case 200 and the lower terminal plate 400 are disposed in contact with each other or an adhesive layer 600 is disposed between the bottom 200b of the case 200 and the lower terminal plate 400.

The electrode assembly 100 may be hermetically sealed from all directions through the case 200, the cap assembly 300, and the lower terminal plate 400.

The lower terminal plate 400 may extend to the lower part of the side wall 200w of the case 200. That is, the lower terminal plate 400 may be disposed below the side wall 200w of the case 200. Accordingly, the area of the planar shape of the flat portion 400a of the lower terminal plate 400 may be expanded. For example, the lower terminal plate 400 may extend to the lower part of the side wall 200w of the case 200 and cover a portion of the lower part of the side wall 200w of the case 200. In the case of a coin-type battery, the diameter of the lower terminal plate 400 may be larger than the diameter of the top opening TO. In this case, the diameter of the lower terminal plate 400 may be the diameter of the planar shape of the flat portion 400a of the lower terminal plate 400.

According to another example, the lower terminal plate 400 may substantially cover the entire lower portion of the side wall 200w of the case 200. In this case, the area of the planar shape of the flat portion 400a of the lower terminal plate 400 may be substantially equal to the area defined by the outer perimeter of the plane of the bottom 200b of the case 200. For example, in the case of a coin-type battery, the area of a circle which is the planar shape of the flat portion 400a of the lower terminal plate 400 may be substantially equal to the area of a circle having an outer radius of a ring which is a planar shape of the bottom 200b of the case 200. That is, the diameter of the lower terminal plate 400 and the diameter of the bottom 200b of the case 200 may be substantially the same. In this case, the diameter of the lower terminal plate 400 may be the diameter of the planar shape of the flat portion 400a of the lower terminal plate 400, and the diameter of the bottom 200b of the case 200 may be the outer radius of the ring when the bottom 200b has a ring shape.

In the case where the lower terminal plate 400 included in the secondary battery 10 according to the exemplary embodiment extends to the lower part of the side wall 200w of the case 200, the phenomenon of the secondary battery 10 being bent or cracked by an external force may be reduced, similar to the above-described case where the upper terminal plate 320 extends to the upper part of the side wall 200w of the case 200. Accordingly, a secondary battery in which stress may be well distributed may be provided.

In the case where the secondary battery 10 according to the exemplary embodiment includes the adhesive layer 600 disposed between the lower terminal plate 400 and the case 200, the adhesive layer 600 may also be disposed to extend to the lower part of the side wall 200w of the case 200 together with the lower terminal plate 400.

The secondary battery 10 according to the exemplary embodiment may include the external terminal 500. Specifically, the external terminal 500 may include the first external terminal 510 and the second external terminal 520. The first external terminal 510 may be an external positive terminal, and the second external terminal 520 may be an external negative terminal. The first external terminal 510 may be in contact with the upper terminal plate 320. The second external terminal 520 may be in contact with the lower terminal plate 400. The first external terminal 510 may be electrically connected to the upper terminal plate 320. The second external terminal 520 may be electrically connected to the lower terminal plate 400. The first external terminal 510 and the second external terminal 520 may be disposed apart from each other. Additionally, the first external terminal 510 and the second external terminal 520 may not be electrically connected to each other.

The first external terminal 510 may include the first body 511 and the second body 512. The first body 511 may be in contact with the upper terminal plate 320 and disposed on the upper terminal plate 320. The second body 512 may be in contact with the side wall 200w of the case 200. The second body 512 may be bent from the first body 511 and extended in the thickness direction of the electrode assembly 100. For example, the first body 511 may be extended in one direction without being bent. In this case, the first body 511 may maintain a constant distance from the cap plate 310. The second body 512 may be in contact with the outer surface of the side wall 200w of the case 200, and in this case, the second body 512 may be electrically insulated from the second electrode 120.

The first electrode 110, the upper terminal plate 320, and the first external terminal 510 may be electrically connected to each other. The second electrode 120, the lower terminal plate 400, and the second external terminal 520 may be electrically connected to each other.

The length of the first body 511 of the first external terminal 510 may be about 1/10 to 1 time the length of the major axis of the planar shape of the bottom 200b of the case 200. In this case, the length of the first body 511 may correspond to the length of the first body 511 in the cross-sectional view. However, the length of the first external terminal 510 may be selected to any length that allows it to be electrically connected to the upper terminal plate 320.

For example, when the upper terminal plate 320 does not extend to the upper part of the side wall 200w of the case 200, a cavity may be created between the first body 511 and the cap plate 310. When the upper terminal plate 320 extends to the upper part of the side wall 200w of the case 200, the volume of the cavity may be reduced. For example, when the upper terminal plate 320 substantially covers the entire upper part of the side wall 200w of the case 200, the volume of the cavity may be substantially minimized.

For example, the plane of the flat portion 320a of the upper terminal plate 320 may have a circular shape, and the planar shape of the first body 511 of the first external terminal 510 may be a rectangular shape. In this case, two vertices located on one side end of the first external terminal 510 may protrude outside the side wall 200w of the case 200 on the plan view. In another example, the planar shape of the first body 511 of the first external terminal 510 may be a shape in which one side of a rectangle is replaced with an arc. In this case, the arc may be a portion of a circular shape of the flat portion 320a of the upper terminal plate 320. In this case, on the plan view, the first body 511 may be located inside and at the boundary of the side wall 200w of the case 200, and the lower surface of the first body 511 may be in contact with the upper terminal plate 320 as a whole. According to the above examples, the volume of the cavity formed between the first body 511 and the cap plate 310 may be reduced. The planar shape of the above first body 511 is only an example, and various planar shapes may be selected.

As the volume of the cavity decreases, a phenomenon of the first body 511 being bent or cracked by an external force may be reduced. That is, stress may be well distributed and durability may be increased.

For example, the second body 512 of the first external terminal 510 may be bent from the first body 511 and disposed in contact with the side wall 200w of the case 200. In this case, the second body 512 may be disposed in contact with the outer surface located outside the side wall 200w. The second body 512 may extend in the thickness direction of the electrode assembly 100 or the secondary battery 10. In another example, the second body 512 may be disposed along one direction in contact with the outer surface of the side wall 200w of the case 200.

The length of the second body 512 of the first external terminal 510 may be about 1/10 to 1 time the height of the case 200, i.e., the height of the side wall 200w of the case 200. In this case, the length of the second body 512 may correspond to the length of the second body 512 in the cross-sectional view. However, the length of the second body 512 may be selected to be a length that allows the first external terminal 510 and the second external terminal 520 to be spaced apart from each other, or a length that allows the first external terminal 510 and the lower terminal plate 400 to be spaced apart from each other.

One surface of the second body 512 in contact with the side wall 200w of the case 200 may be flat or curved. For example, when the secondary battery 10 is a coin-type or button-type battery and one side of the second body 512 is flat, only a part of one side of the second body 512 that comes into contact with the side wall 200w of the case 200 may come into contact with the side wall 200w of the case 200. According to another embodiment, when the secondary battery 10 is a coin-type or button-type battery and one side of the second body 512 is curved, at least a portion of or substantially all of the side of the second body 512 that comes into contact with the side wall 200w of the case 200 may come into contact with the outer surface of the side wall 200w of the case 200. The curved surface of the second body 512 that comes into contact with the side wall 200w of the case 200 may be a part of the curved surface included in the outer surface of the side wall 200w of the case 200. In this case, the area of the region where the second body 512 and the side wall 200w of the case 200 come into contact may increase.

Because the second body 512 and the side wall 200w of the case 200 are in contact with each other without being separated from each other, a phenomenon of the second body 512 being bent or cracked by an external force may be reduced. That is, the durability of the secondary battery 10 may be increased. Therefore, the larger the area of the region where the second body 512 and the side wall 200w of the case 200 come into contact, the better the durability may be.

The first external terminal 510 of the secondary battery 10 according to the exemplary embodiment may include the additional body 518. The additional body 518 may be bent from the second body and extended away from the side wall 200w of the case 200. The additional body 518 may be disposed apart from the side wall 200w of the case 200.

The second external terminal 520 may be connected to the lower terminal plate 400. The second external terminal 520 may be disposed in one direction. The second external terminal 520 may protrude from the bottom 200b of the case 200 by a certain length.

The length of the second external terminal 520 may be about 1/10 to 1 time the length of the major axis of the planar shape of the bottom 200b of the case 200. Similarly, the length of the second external terminal 520 may be selected to be a length that allows it to be electrically connected to the lower terminal plate 400.

The secondary battery 10 according to the exemplary embodiment may further include the adhesive layer 600. According to one example, the secondary battery 10 may include the adhesive layer 600 that bonds the cap plate 310 and the upper terminal plate 320. According to another example, the secondary battery may include an adhesive layer 600 that bonds the bottom 200b of the case 200 and the lower terminal plate 400.

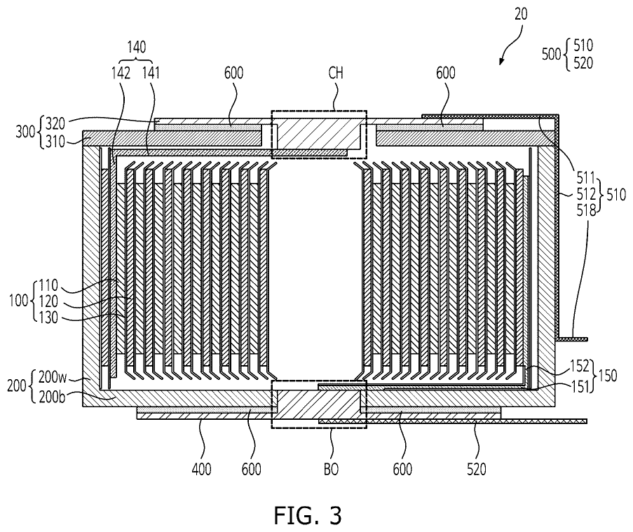

FIG. 3 is a cross-sectional view of a secondary battery according to an exemplary embodiment.

Referring to FIG. 3, the case 200 of the secondary battery 20 according to the exemplary embodiment may include the bottom opening BO. The second electrode 120 may be connected to the second electrode tab 150, and the second electrode tab 150 may be connected to the lower terminal plate 400 through the bottom opening BO.

In FIG. 3, the first external terminal 510 may be disposed in contact with the outer surface of the side wall 200w of the case 200. The length of the first body 511 included in the first external terminal 510 may be less than half the length of the major axis of the planar shape of the bottom 200b of the case 200. The length of the second body 512 included in the first external terminal 510 may be equal to or greater than half the height of the case 200, and may be less than the height of the case 200. In this case, the height of the case 200 may correspond to the height of the side wall 200w of the case 200. The length of the second external terminal 520 may be equal to or greater than half of the length of the major axis of the planar shape of the bottom 200b of the case 200.

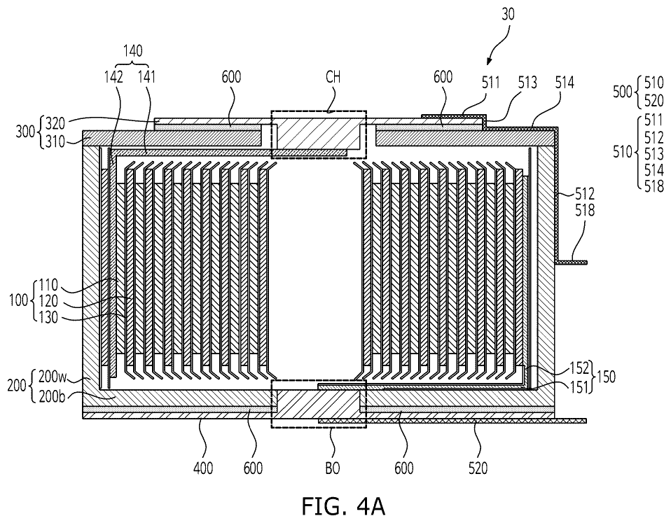

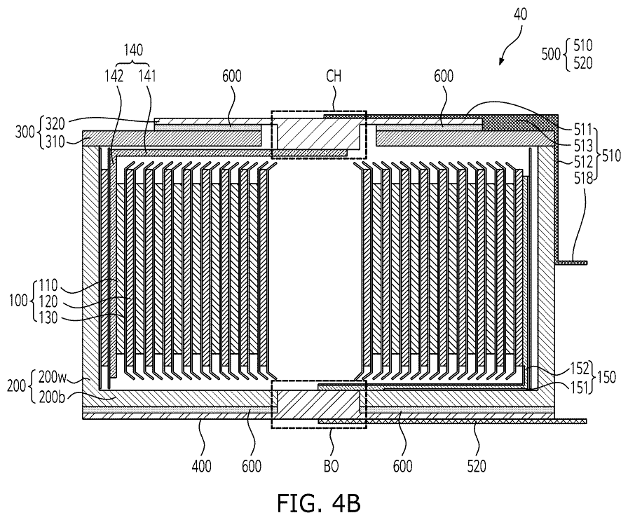

FIG. 4A is a cross-sectional view of a secondary battery according to an exemplary embodiment, and FIG. 4B is a cross-sectional view of a secondary battery according to another exemplary embodiment.

Referring to FIG. 4A, the case 200 of the secondary battery 30 according to the exemplary embodiment may include the bottom opening BO, and the first external terminal 510 may be disposed in contact with the outer surface of the side wall 200w of the case 200.

The first external terminal 510 may include the first to fourth bodies 511, 512, 513, 514. For example, the first external terminal 510 may be in contact with the upper terminal plate 320. In this case, when the upper terminal plate 320 does not cover the upper surface of the side wall 200w of the case 200, in the secondary battery 10 according to the exemplary embodiment, a thickness from the bottom 200b of the case 200 to the cap plate 310 and a thickness from the bottom 200b to the upper terminal plate 320 may be different. The third body 513 may be bent from the first body 511 and disposed in contact with the side surface of the upper terminal plate 320, and may cover the region exposed by the difference in the two thicknesses. The fourth body 514 may be bent from the third body 513 and disposed in contact with the upper surface of the cap plate 310. The second body 512 may be bent from the fourth body 514 and disposed in contact with the outer surface of the side wall 200w of the case 200. In this case, the volume of the cavity between the first body 511 and the cap plate 310 may be reduced. Additionally, the first external terminal 510 may include a fifth body 518a that is bent from the second body 512 and extends away from the side wall 200w of the case 200.

Referring to FIG. 4B, the case 200 of the secondary battery 40 according to the exemplary embodiment may include the bottom opening BO, and the first external terminal 510 may be disposed in contact with the outer surface of the side wall 200w of the case 200.

The first external terminal 510 may include first to third bodies 511, 512, 513. For example, the first external terminal 510 may be in contact with the upper terminal plate 320. In this case, when the upper terminal plate 320 does not cover the upper surface of the side wall 200w of the case 200, in the secondary battery 10 according to the exemplary embodiment, a thickness from the bottom to the cap plate 310 and a thickness from the bottom to the upper terminal plate 320 may be different. The third body 513 may be an extended portion from the first body 511, but may have a different thickness from the first body 511. The third body 513 has a thickness greater than that of the first body 511, so that the thickness from the bottom 200b of the case 200 to the upper surface of the first body 511 of the first external terminal 510 and the thickness from the bottom 200b to the upper surface of the third body 513 of the first external terminal 510 may be substantially the same. The second body 512 may be bent from the third body 513 and disposed in contact with the outer surface of the side wall 200w of the case 200. Additionally, the first external terminal 510 may include a fourth body 518b that is bent from the second body 512 and extends away from the side wall 200w of the case 200.

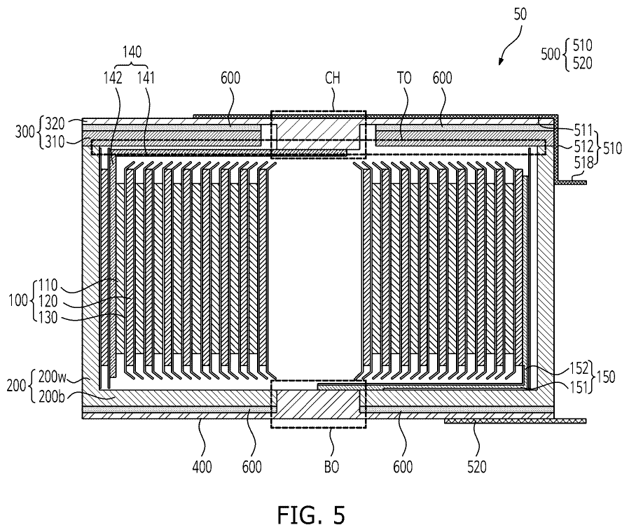

FIG. 5 is a cross-sectional view of a secondary battery according to an exemplary embodiment.

Referring to FIG. 5, the case 200 of the secondary battery 50 according to the exemplary embodiment may include the bottom opening BO, and the first external terminal 510 may be disposed in contact with the outer surface of the side wall 200w of the case 200. Additionally, the upper terminal plate 320 and the adhesive layer 600 may substantially cover the entire upper portion of the side wall 200w of the case 200. For example, when the secondary battery 50 is a coin-type or button-type battery, the diameters of the upper terminal plate 320 and the case 200 may be substantially the same. Additionally, the lower terminal plate 400 and the adhesive layer 600 may substantially cover the entire lower portion of the side wall 200w of the case 200. For example, when the secondary battery 50 is a coin-type or button-type battery, the diameters of the lower terminal plate 400 and the case 200 may be substantially the same.

The length of the first body 511 included in the first external terminal 510 may be equal to or greater than half of the length of the major axis of the planar shape of the bottom 200b of the case 200. The length of the second body 512 included in the first external terminal 510 may be less than half the height of the case 200. In this case, the height of the case 200 may correspond to the height of the side wall 200w of the case 200. The length of the second external terminal 520 may be less than half the length of the major axis of the planar shape of the bottom 200b of the case 200.

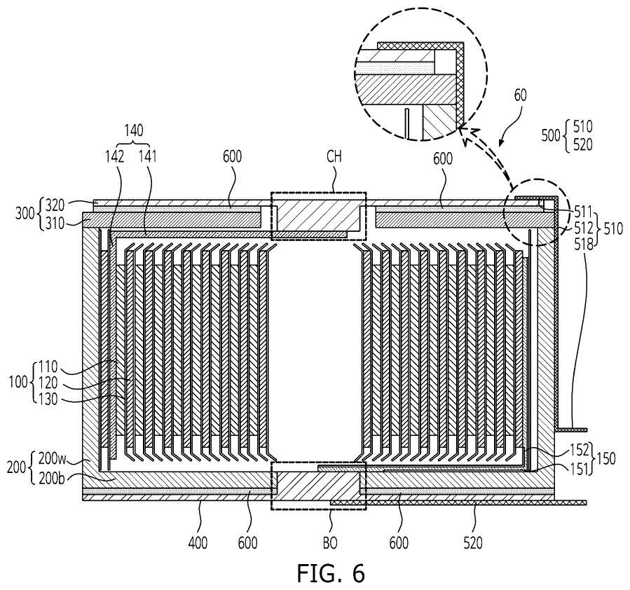

FIG. 6 is a detailed view showing a cross-section of a secondary battery according to an exemplary embodiment and a part thereof.

Referring to FIG. 6, the case 200 of the secondary battery 60 according to the exemplary embodiment may include the bottom opening BO, and the first external terminal 510 may be disposed in contact with the outer surface of the side wall 200w of the case 200. Additionally, the upper terminal plate 320 and the adhesive layer 600 may cover a portion of the upper part of the side wall 200w of the case 200. For example, when the secondary battery 60 is a coin-type or button-type battery, the diameter of the upper terminal plate 320 may be larger than the diameter of the top opening TO. By extending the upper terminal plate 320 to the upper part of the side wall 200w of the case 200, the volume of the cavity between the first external terminal 510 and the cap plate 310 may be reduced. Additionally, the lower terminal plate 400 and the adhesive layer 600 may cover a portion of the lower part of the side wall 200w of the case 200. For example, when the secondary battery 60 is a coin-type or button-type battery, the diameter of the lower terminal plate 400 may be larger than the diameter of the top opening TO. By extending the lower terminal plate 400 to the lower part of the side wall 200w of the case 200, the volume of the cavity between the second external terminal 520 and the bottom 200b of the case 200 may be reduced.

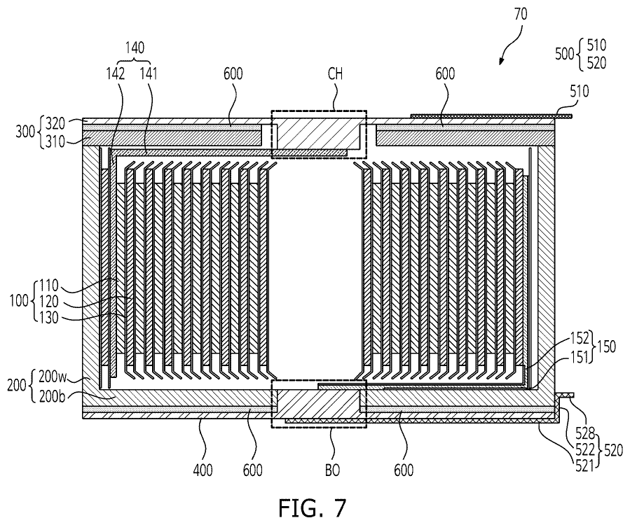

FIG. 7 is a cross-sectional view of a secondary battery according to an exemplary embodiment.

Referring to FIG. 7, the case 200 of the secondary battery 70 according to the exemplary embodiment may include the bottom opening BO, and the first external terminal 510 may be disposed in contact with the outer surface of the side wall 200w of the case 200. The upper terminal plate 320 and the adhesive layer 600 may substantially cover the entire upper portion of the side wall 200w of the case 200. Additionally, the lower terminal plate 400 and the adhesive layer 600 may substantially cover the entire lower portion of the side wall 200w of the case 200.

The first external terminal 510 may be in contact with the upper terminal plate 320 and may be disposed in one direction. The first external terminal 510 has a certain length and may protrude outside the outer surface of the side wall 200w of the case 200 on the plan view. The length of the first external terminal 510 may be less than half the length of the major axis of the planar shape of the bottom 200b of the case 200.

The second external terminal 520 may include a first body 521 and a second body 522. The length of the first body 521 included in the second external terminal 520 may be equal to or greater than half of the length of the major axis of the planar shape of the bottom 200b of the case 200. The length of the second body 522 including the second external terminal 520 may be less than half the thickness of the case 200. The second external terminal 520 may further include a third body 528 that is bent from the second body 522 and extends away from the side wall 200w of the case 200.

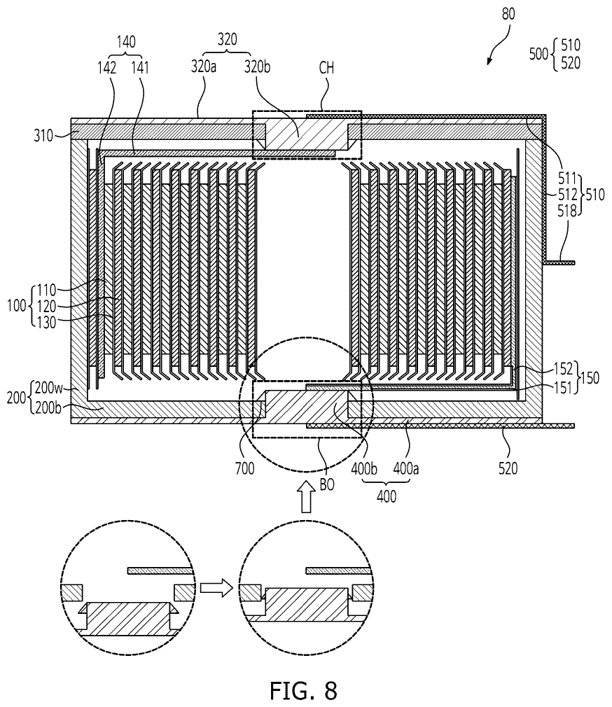

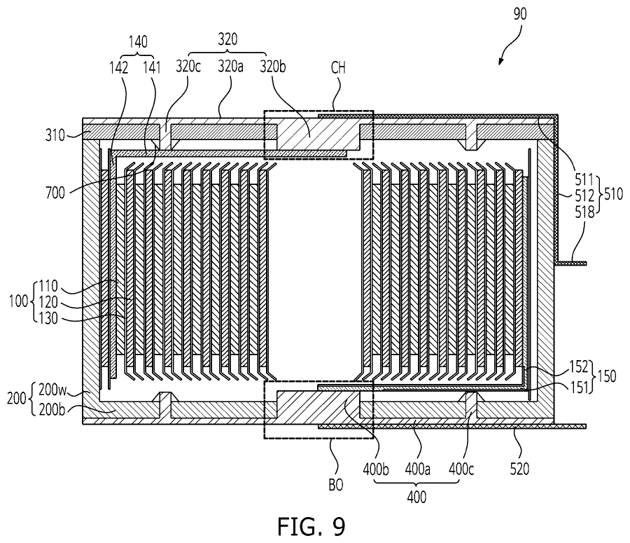

FIG. 8 is a diagram showing a cross-section of a secondary battery according to an exemplary embodiment and a fastening process by a fastening portion, and FIG. 9 is a cross-section of a secondary battery according to another exemplary embodiment.

According to FIGS. 8 and 9, a secondary battery 80 according to the exemplary embodiment may further include a fastening portion 700 as an alternative or additional to the adhesive layer 600. Referring to FIG. 8, the fastening portion 700 may be disposed on the side surface of the protrusion 320b of the upper terminal plate 320 or the side surface of the protrusion 400b of the lower terminal plate 400. The fastening portion 700 may be configured as a spring structure and may be inserted into the inside of the side of the protrusion 320b of the upper terminal plate 320 or the inside of the side of the protrusion 400b of the lower terminal plate 400 by an external force. The fastening portion 700 may protrude outside the protrusion 320b of the upper terminal plate 320 before the upper terminal plate 320 fills the conducting hole CH. The fastening portion 700 may be inserted into the inside of the side of the protrusion 320b of the upper terminal plate 320, which does not interfere when the upper terminal plate 320 is inserted into the conducting hole CH. The fastening portion 700 that has passed through the conducting hole CH may protrude again outside the protrusion 320b of the upper terminal plate 320 by a spring. The width of the protrusion 320b including the fastening portions 700 disposed on both sides of the protrusion 320b may be larger than the width of the conducting hole CH. In this case, the fastening portion 700 may fasten the upper terminal plate 320 to the cap plate 310 such that the protrusion 320b of the upper terminal plate 320 does not come out again through the conducting hole CH. The upper terminal plate 320 and the cap plate 310 may be fastened by the fastening portion 700, and the flat portion 320a of the upper terminal plate 320 may come into contact with the cap plate 310. The thickness of the fastening portion 700 may be appropriately selected such that the upper terminal plate 320 is fixed. The cross-sectional shape of the fastening portion 700 may be, e.g., a triangle, and may be selected from shapes that enable the fastening portion 700 to be easily inserted into the conducting hole CH but not easily separated. The above description may also be applied to a case where the fastening portion 700 is disposed on the protrusion 400b of the lower terminal plate 400. The electrode assembly 100 may be hermetically sealed by fastening the lower terminal plate 400 and the case 200. Alternatively, the protrusion 320b of the upper terminal plate 320 and/or the protrusion 400b of the lower terminal plate 400 may be fastened to the cap plate 310 and/or the case 200 in a force-fit manner.

According to FIG. 9, one of reliefs 320c or openings capable of receiving reliefs may be formed on the flat portion 320a of the upper terminal plate 320. For example, the fastening portion 700 may be disposed on the relief 320c formed on the flat portion 320a of the upper terminal plate 320. In this case, the other one of reliefs or openings capable of receiving reliefs may be formed in the cap plate 310 that is in contact with the upper terminal plate 320. For example, when the relief 320c is formed on the upper terminal plate 320, the fastening portion 700 may be disposed on the relief 320c. The fastening portion 700 may be formed so as not to interfere when inserted into the opening in the cap plate 310. When the flat portion 320a of the upper terminal plate 320 and the cap plate 310 come into contact, the flat portion 320a and the cap plate 310 may be fastened by the fastening portion 700, and the flat portion 320a of the upper terminal plate 320 may come into contact with the cap plate 310. The thickness of the fastening portion 700 may be appropriately selected such that the upper terminal plate 320 is fixed. Conversely, the cap plate 310 may have a relief and the flat portion 320a of the upper terminal plate 320 may have an opening. The above description may also be applied to the lower terminal plate 400 and the bottom 200b of the case 200. For example, a relief 400c may be formed on a flat portion 400a of the lower terminal plate 400.

The secondary battery 10 according to the exemplary embodiment may include various configurations capable of hermetically sealing the electrode assembly 100. For example, an upper terminal plate 320 and a lower terminal plate 400 may be disposed, which may include rivets and include protrusions having screws, so that the bottom opening BO of the case 200 and the conducting hole CH of the cap plate may also include screws that engage with the screws.

The secondary battery 10, 20, 30, 40, 50, 60, 70, 80, or 90 according to the exemplary embodiment may be a coin-type or button-type battery. However, the secondary battery 10, 20, 30, 40, 50, 60, 70, 80, 90 according to the exemplary embodiment may be a pouch-shaped, cylindrical, or square battery.

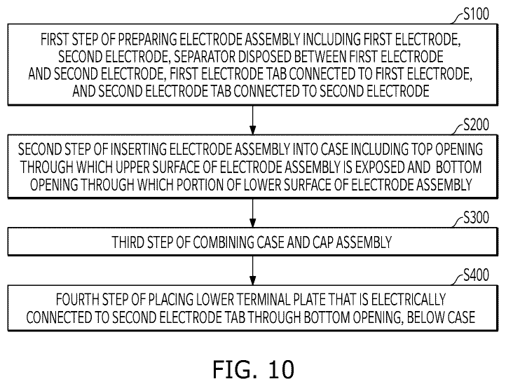

FIG. 10 is a flow chart of a method for manufacturing a secondary battery, according to an exemplary embodiment.

Referring to FIG. 10, a method for manufacturing a secondary battery, according to an exemplary embodiment includes a first step S100 of preparing an electrode assembly 100 including a first electrode 110, a second electrode 120, a separator 130 disposed between the first electrode 110 and the second electrode 120, a first electrode tab 140 connected to the first electrode 110, and a second electrode tab 150 connected to the second electrode 120, a second step S200 of inserting the electrode assembly 100 into a case 200 that includes the top opening TO through which an upper surface of the electrode assembly 100 is exposed and the bottom opening BO through which a portion of a lower surface of the electrode assembly is exposed, a third step S300 of combining the case 200 and the cap assembly 300, and a fourth step S400 of placing a lower terminal plate 400 that is electrically connected to the second electrode tab 150 through the bottom opening BO, below the case 200. In this case, the cap assembly 300 may include a cap plate 310 that is combined with the case 200 to cover a portion of the top opening TO and has the conducting hole CH formed therein through which the remaining portion of the top opening of the case 200 is exposed, and an upper terminal plate 320 that is disposed above the cap plate 310 and is electrically connected to the first electrode tab 140 through the conducting hole CH.

For example, in the method for manufacturing a secondary battery, according to an exemplary embodiment, in the third step S300, the upper terminal plate 320 may be disposed to extend to the upper part of the side wall 200w of the case 200. In another example, in the third step S300, the upper terminal plate 320 may be disposed to partially cover the upper portion of the side wall 200w of the case 200 or substantially cover the entire upper portion.

For example, in the method for manufacturing a secondary battery, according to an exemplary embodiment, in the fourth step S400, the lower terminal plate 400 may be disposed to extend to the lower part of the side wall 200w of the case 200. In another example, in the fourth step S400, the lower terminal plate 400 may be disposed to partially cover the lower portion of the side wall 200w of the case 200 or substantially cover the entire lower portion.

In a method for manufacturing a secondary battery, according to an exemplary embodiment, the case 200 and the cap plate 310 may be formed of an insulating material. In this case, the third step S300 may include a step of bonding the case 200 and the cap plate 310. For example, the bonding may be performed using resin. The bonding between the case 200 and the cap plate 310 may be plastic bonding.

In the method for manufacturing a secondary battery, according to an exemplary embodiment, the third step S300 and the fourth step S400 may be performed simultaneously or may be performed regardless of the order.

The method for manufacturing a secondary battery, according to an exemplary embodiment, may include a fifth step of placing the first external terminal 510 to be in contact with the upper terminal plate 320 after the fourth step S400, and a sixth step of placing the second external terminal 520 to be in contact with the lower terminal plate 400. In this case, the fifth step and the sixth step may be performed simultaneously or may be performed regardless of the order.

The first external terminal 510 may include the first body 511, the second body 512, and the additional body 518. The first body 511 may be in contact with the upper terminal plate 320 and may be disposed to extend in one direction on the upper terminal plate 320. The second body 512 may be bent from the first body 511 to be in contact with the side wall 200w of the case 200, and may be disposed to extend in the thickness direction of the case 200 along the outer surface of the side wall 200w. The additional body 518 may be bent from the second body 512 and disposed to be extended away from the side wall 200w of the case 200.

In addition, a method for manufacturing the secondary battery 10, 20, 30, 40, 50, 60, 70, 80, and 90 according to the exemplary embodiments described above may be included. However, this is only an exemplary embodiment and is not limited thereto.

By way of summation and review, when manufacturing a coin-type secondary battery, a separate insulation process may be required when arranging an external positive terminal and an external negative terminal. By covering the side surface of the case accommodating the electrode assembly inside with an insulating layer to form a housing, short circuits may be prevented from occurring at the external positive terminal and the external negative terminal. However, when manufacturing a coin-type secondary battery including a housing, energy density of the secondary battery may be low.

In contrast, a secondary battery according to an exemplary embodiment may provide a secondary battery without a housing. A secondary battery according to an exemplary embodiment may provide a secondary battery that is resistant to external impact. A method for manufacturing a secondary battery, according to an exemplary embodiment may provide a method for manufacturing a secondary battery without a housing.

That is, a secondary battery according to an exemplary embodiment may provide high energy density by using a case formed of an insulating material without a separate housing. According to the exemplary embodiment, the secondary battery that is resistant to external impact may be provided. According to the exemplary embodiment, the secondary battery having a low possibility of short circuit occurrence may be provided. The method for manufacturing a secondary battery, according to an exemplary embodiment may provide a secondary battery having a high energy density.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode, a second electrode, a separator between the first electrode and the second electrode, a first electrode tab connected to the first electrode, and a second electrode tab connected to the second electrode;
a case that accommodates the electrode assembly, the case including a top opening through which an upper surface of the electrode assembly is exposed and a bottom opening through which a portion of a lower surface of the electrode assembly is exposed;
a cap plate that is combined with the case to cover a portion of the top opening, the cap plate having a conducting hole through which a remaining portion of the top opening of the case is exposed;
an upper terminal plate above the cap plate and electrically connected to the first electrode tab through the conducting hole; and
a lower terminal plate below the case and electrically connected to the second electrode tab through the bottom opening.

2. The secondary battery according to claim 1, wherein:
the second electrode tab includes a first body and a second body,
the first body is between the electrode assembly and a lower surface of the case,
the first body is electrically connected to the lower terminal plate, and
the second body is bent from the first body and electrically connected to the second electrode.

3. The secondary battery according to claim 1, wherein each of the case and the cap plate includes an insulating material.

4. The secondary battery according to claim 3, wherein the insulating material is a fiber-reinforced plastic.

5. The secondary battery according to claim 1, wherein a diameter of the upper terminal plate is larger than a diameter of the top opening of the case.

6. The secondary battery according to claim 5, wherein the diameter of the upper terminal plate and the diameter of the case are the same.

7. The secondary battery according to claim 1, wherein a thickness of the cap plate is thinner than a thickness of the case.

8. The secondary battery according to claim 1, wherein a diameter of the lower terminal plate is larger than a diameter of the top opening of the case.

9. The secondary battery according to claim 8, wherein the diameter of the lower terminal plate and the diameter of the case are the same.

10. The secondary battery according to claim 1, wherein a diameter of the cap plate and a diameter of the case are the same.

11. The secondary battery according to claim 10, wherein the cap plate and the case are combined by plastic bonding.

12. The secondary battery according to claim 1, further comprising:
a first external terminal connected to the upper terminal plate; and
a second external terminal connected to the lower terminal plate.

13. The secondary battery according to claim 12, wherein:
the first external terminal includes a first body and a second body,
the first body is in contact with the upper terminal plate, and
the second body is bent from the first body to be in contact with a side surface of the case.

14. The secondary battery according to claim 13, wherein:
the first external terminal further includes a third body, and
the third body is bent from the second body and extends away from the side surface of the case.

15. The secondary battery according to claim 12, wherein:
the second external terminal includes a first body and a second body,
the first body is in contact with the lower terminal plate, and
the second body is bent from the first body to be in contact with a side surface of the case.

16. The secondary battery according to claim 15, wherein:
the second external terminal further includes a third body, and
the third body is bent from the second body and extends away from the side surface of the case.

17. The secondary battery according to claim 1, wherein:
the upper terminal plate includes a first flat portion above the cap plate and a first protrusion protruding on the first flat portion,
the first protrusion is received in the conducting hole of the cap plate, and
the first protrusion is electrically connected to the first electrode tab.

18. The secondary battery according to claim 17, wherein:
the lower terminal plate includes a second flat portion on the lower surface of the case and a second protrusion protruding on the second flat portion,
the second protrusion is received in the bottom opening of the case, and
the second protrusion is electrically connected to the second electrode tab.

19. A method for manufacturing a secondary battery, the method comprising:
preparing an electrode assembly including a first electrode, a second electrode, a separator disposed between the first electrode and the second electrode, a first electrode tab connected to the first electrode, and a second electrode tab connected to the second electrode;
inserting the electrode assembly into a case including a top opening through which an upper surface of the electrode assembly is exposed and a bottom opening through which a portion of a lower surface of the electrode assembly is exposed;
combining the case and a cap assembly; and
placing a lower terminal plate that is electrically connected to the second electrode tab through the bottom opening, below the case,
wherein the cap assembly includes:
a cap plate that is combined with the case to cover a portion of the top opening, and has a conducting hole formed therein through which a remaining portion of the top opening of the case is exposed, and
an upper terminal plate that is disposed above the cap plate and is electrically connected to the first electrode tab through the conducting hole.

20. The method for manufacturing a secondary battery as claimed in claim 19, wherein:
each of the case and the cap plate is formed of an insulating material, and
combining the case and the cap assembly includes bonding the cap plate and the case by plastic bonding.
